(19) United States
(12) Patent Application Publication
(10) Pub. No.: US 2026/0098511 A1
(43) Pub. Date: Apr. 9, 2026

(54) HYDROCARBON ABSORBING AIR FILTER SYSTEM

(71) Applicant: K&N Engineering, Inc., Corona, CA (US)

(72) Inventors: Gilbert Heck, Riverside, CA (US); Steve Williams, Cherry Valley, CA (US)

(73) Assignee: K&N Engineering, Inc., Corona, CA (US)

(21) Appl. No.: 19/348,560

(22) Filed: Oct. 2, 2025

Related U.S. Application Data
(60) Provisional application No. 63/704,410, filed on Oct. 7, 2024.

(51) Int. Cl. F02M 35/024; F02M 35/02

(52) U.S. Cl. CPC F02M 35/02425; F02M 35/0218

(57) ABSTRACT

A system and methods are provided for a hydrocarbon absorbing air filter system to arrests evaporative hydrocarbon emissions from an intake duct of an internal combustion engine. The system comprises an air filter box that includes an air inlet to an air filter disposed inside the air filter box. A hydrocarbon trap outside the air filter box and in fluid communication with the air filter absorbs evaporative hydrocarbon emissions leaking from the air intake duct when the engine is not operating. The hydrocarbon trap includes an outer housing that couples with an inner housing and a hydrocarbon absorbing pad within an interior between the outer and inner housings. Ports in the inner housing allow hydrocarbon emissions to be arrested by the hydrocarbon absorbing pad. A conduit extends from the hydrocarbon trap to the air intake duct of the internal combustion engine.

### PRIORITY

This application claims the benefit of and priority to U.S. Provisional Application, entitled “Hydrocarbon Absorbing Air Filter System,” filed on Oct. 7, 2024, and having application Ser. No. 63/704,410, the entirety of said application being incorporated herein by reference.

### FIELD

Embodiments of the present disclosure generally relate to engine air intake systems. More specifically, embodiments of the disclosure relate to a system and methods for a hydrocarbon absorbing air filter system that exhibits a low resistance to airflow and arrests evaporative hydrocarbon emissions from an intake manifold of an internal combustion engine after engine shutdown.

### BACKGROUND

An air intake filter removes particulate matter from air entering an air intake manifold of a motor vehicle. A variety of filter shapes have evolved over time for this purpose, such as flat panel, ring, cylindrical and frustoconical (section of a cone) designs. While air filters have largely served the purpose of removing particulate matter, such as dirt or debris, from the air entering the air intake manifold, such filters provide little help in preventing evaporative emissions from leaking out of the intake manifold and entering the atmosphere. Such emissions, arising chiefly when the engine is turned off and the intake manifold is hot, are a well-known contributor to air pollution.

During operation of an internal combustion engine, an airflow is drawn through the air intake system into an intake manifold and then finally into combustion chambers of the engine. The airflow is caused by the intake stroke of pistons within the engine, which forms an internal pressure within the intake manifold that is lower than the atmospheric pressure of the environment, and thus outside air is drawn into the air intake system. Evaporative emissions are prevented from exiting the air intake system due to the low internal pressure within the intake manifold and the airflow into the air intake system during operation of the internal combustion engine.

After engine shut-down, air continues to rush through the air intake system until the internal pressure within the intake manifold equals the atmospheric pressure of the environment. Evaporative hydrocarbons may be emitted if un-combusted fuel is present in the air intake system, such as due to pressurized fuel leaking from fuel rail(s) into the intake manifold through fuel injectors. This small amount of fuel may vaporize, and the resulting hydrocarbon vapor may migrate out of the air intake system into the atmosphere. Although such hydrocarbon vapor egress was once considered negligible, current regulations and environmental awareness have created a desire to eliminate evaporative emissions from the air intake systems of internal combustion engines.

Attempts to eliminate evaporative hydrocarbon emissions have included placing secondary, hydrocarbon adsorbing filters directly across the path of airflow into the air intake system. As will be appreciated, however, disposing extra layers of filtration media across the airflow path causes an additional flow restriction to be placed onto the air intake system. As such, the internal combustion engine is generally less efficient, or the air intake system may need to be increased in size so as to compensate for the increased flow restriction.

Other attempts to eliminate evaporative hydrocarbon emissions have included combining hydrocarbon vapor-adsorbing materials with conventional air filters. One drawback associated with these combination filters includes vapor-adsorbing materials flaking out of the combination filter and entering the air intake system. Further, such a loss of vapor-adsorbing materials may adversely affect the vapor absorbance of the combination filter. Accordingly, there is a need for eliminating hydrocarbon leakage from air intake systems of internal combustion engines without adversely affecting engine performance.

### SUMMARY

A system and methods are provided for a hydrocarbon absorbing air filter system to arrests evaporative hydrocarbon emissions from an intake duct of an internal combustion engine. The system comprises an air filter box that includes an air inlet to an air filter disposed inside the air filter box. A hydrocarbon trap outside the air filter box and in fluid communication with the air filter absorbs evaporative hydrocarbon emissions leaking from the air intake duct when the engine is not operating. The hydrocarbon trap includes an outer housing that couples with an inner housing and a hydrocarbon absorbing pad within an interior between the outer and inner housings. Ports in the inner housing allow hydrocarbon emissions to be arrested by the hydrocarbon absorbing pad. A conduit extends from the hydrocarbon trap to the air intake duct of the internal combustion engine.

In an exemplary embodiment, a system for absorbing evaporative hydrocarbon emissions from an internal combustion engine comprises: an air filter box including one or more air inlets to an interior of the air filter box; an air filter disposed within the interior; a hydrocarbon trap in fluid communication with the air filter; and a conduit extending from the hydrocarbon trap to an air intake duct of the internal combustion engine.

In another exemplary embodiment, the air filter is disposed within the interior and configured to remove particulate matter and contaminants that may be flowing with the airstream before the airstream passes through the hydrocarbon trap and then is directed through a conduit to an air intake duct of the internal combustion engine. In another exemplary embodiment, the hydrocarbon trap is configured to absorb evaporative hydrocarbon emissions leaking from the air intake duct when the internal combustion engine is not operating.

In another exemplary embodiment, the air filter box generally comprises a housing that is configured to improve movement of the airstream through the air filter. In another exemplary embodiment, the housing is configured to support the air filter and provides an interface between an interior of the air filter and the air intake duct of the engine. In another exemplary embodiment, the housing includes a mount portion that enables coupling the air filter with an interior surface of the housing.

In another exemplary embodiment, the mount portion supports the air filter inside the air filter box and also supports the hydrocarbon trap outside the air filter box. In another exemplary embodiment, the mount portion is secured to the housing by way of suitable fasteners. In another exemplary embodiment, the hydrocarbon trap is secured to the mount portion by way of a clamp.

In another exemplary embodiment, the hydrocarbon trap comprises an outer housing that couples with an inner housing and at least one hydrocarbon absorbing pad within an interior between the outer housing and the inner housing. In another exemplary embodiment, ports are disposed along the sidewall of the inner housing to allow evaporative hydrocarbon emissions to be drawn to and arrested by the hydrocarbon absorbing pad. In another exemplary embodiment, the outer housing and the inner housing are generally concentric with the inner housing retained entirely within the interior of the outer housing to prevent evaporative hydrocarbon emissions from escaping into the atmosphere by way of the interior between the outer housing and the inner housing.

In another exemplary embodiment, the inner housing is held fixed within the outer housing by way of a tamper resistant lock. In another exemplary embodiment, the tamper resistant lock keeps the inner housing fixated within the outer housing. In another exemplary embodiment, the tamper resistant lock comprises a tooth-like structure that prevents the inner housing from being removed from the interior of the outer housing.

In another exemplary embodiment, the inner housing comprises two or more mount studs that maintain the hydrocarbon absorbing pad disposed in a smooth, unfolded configuration within the interior. In another exemplary embodiment, the mount studs each has a post-like shape that extends radially outward from the exterior surface of the inner housing and fits within a corresponding hole disposed in the hydrocarbon absorbing pad. In another exemplary embodiment, the mount studs and the holes are arranged to keep the hydrocarbon absorbing sheet disposed between the outer housing and the inner housing, as best shown in FIG. 4.

In another exemplary embodiment, the outer housing includes an air filter flange and a conduit flange at opposite ends. In another exemplary embodiment, the air filter flange is directly received into a base of the air filter or coupled with a tube, duct, or adapter comprising a mount portion of the air filter box that houses the air filter. In another exemplary embodiment, the conduit flange is inserted into and secured within the conduit by way of one or more clamps.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an exemplary embodiment of a hydrocarbon absorbing air filter system, according to the present disclosure;

FIG. 2 illustrates an exploded view of an exemplary embodiment of a hydrocarbon absorbing trap that can be incorporated into the hydrocarbon absorbing air filter system of FIG. 1, in accordance with the present disclosure;

FIG. 3 illustrates a side view of an exemplary embodiment of a hydrocarbon absorbing trap that can be incorporated into the hydrocarbon absorbing air filter system of FIG. 1, according to the present disclosure;

FIG. 4 illustrates a cross-sectional view of the hydrocarbon absorbing trap of FIG. 3, taken along line 4-4, in accordance with the present disclosure; and

FIG. 5 illustrates a close-up view of an exemplary embodiment of a lock comprising the hydrocarbon absorbing trap of FIG. 4, within detail area 5, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the hydrocarbon absorbing air filter system and methods disclosed herein may be practiced without these specific details. In other instances, specific numeric references such as “first conduit,” may be made. However, the specific numeric reference should not be interpreted as a literal sequential order but rather interpreted that the “first conduit” is different than a “second conduit.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

During operation of an internal combustion engine, airflow is drawn through the air intake system into an intake manifold and then finally into combustion chambers of the engine. Evaporative emissions are prevented from exiting the air intake system due to low internal pressure within the intake manifold and the airflow into the air intake system during operation of the internal combustion engine. After engine shutdown, however, evaporative hydrocarbon vapor may migrate out of the air intake system into the atmosphere. Attempts to eliminate evaporative hydrocarbon emissions have included placing secondary, hydrocarbon adsorbing filters directly across the path of airflow into the air intake system or combining hydrocarbon vapor-adsorbing materials with conventional air filters. Placing extra layers of filtration media across the airflow path reduces the efficiency of the internal combustion engine while vapor-adsorbing materials can flake out of the combination filter and entering the air intake system. Embodiments herein present a hydrocarbon absorbing air filter system that exhibits low resistance to airflow and arrests evaporative hydrocarbon emissions from an intake manifold of an internal combustion engine after engine shutdown without adversely affecting engine performance.

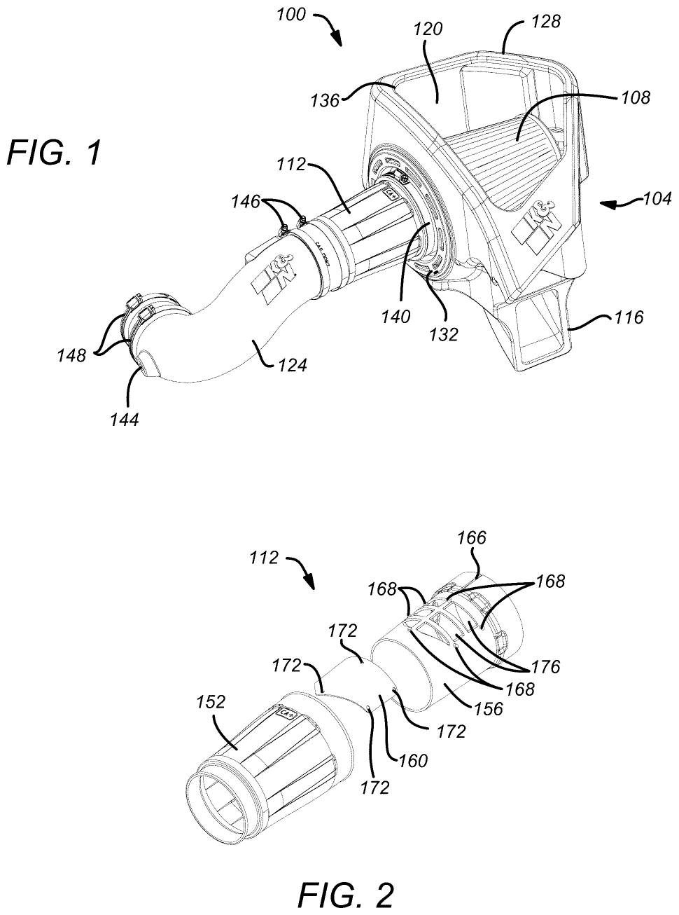

FIG. 1 illustrates an exemplary embodiment of a hydrocarbon absorbing air filter system 100 (hereinafter, “system 100”), according to the present disclosure. The system 100 includes an air filter box 104 that contains an air filter 108 coupled with a hydrocarbon trap 112. The air filter box 104 includes at least one air inlet 116 that communicates an airstream into an interior 120 of the air filter box 104. The air filter 108 is disposed within the interior 120 and configured to remove particulate matter and contaminants that may be flowing with the airstream before the airstream passes through the hydrocarbon trap 112 and then is directed through a conduit 124 to an air intake duct of the internal combustion engine. The hydrocarbon trap 112 is configured to absorb evaporative hydrocarbon emissions leaking from the air intake duct when the internal combustion engine is not operating.

The air filter box 104 generally comprises a housing 128 that is configured to improve movement of the airstream through the air filter 108. The housing 128 is configured to support the air filter 108 and provides an interface between an interior of the air filter 108 and the air intake duct of the engine. It is contemplated that various techniques may be employed to couple the air filter 108 with the interior 120 of the housing 128, without limitation. For example, the housing 128 can include a mount portion 132 that facilitates coupling the air filter 108 with an interior surface of the housing 128 so as to establish an airtight connection between the interior of the air filter 108 and the air intake duct of the engine. In some embodiments, the mount portion 132 can support the air filter 108 inside the air filter box 104 and also supports the hydrocarbon trap 112 outside the air filter box 104. The mount portion 132 can be secured to the housing 128 by way of suitable fasteners. The hydrocarbon trap 112 can be secured to the mount portion 132 by way of a clamp 140, as shown in FIG. 1.

The housing 128 preferably comprises a material that is sufficiently durable and temperature resistant to retain its configuration during operation when coupled with the air intake duct of the engine. It is envisioned that the housing 128 may be formed by way of injection molding, or another similar technique. Moreover, the housing 128 can include an opening 136 that provides access to the interior 120 of the air filter box 104. The opening 136 may be configured to allow unhindered airflow to the air filter 108 and may be used to install and/or service the air filter 108. In some embodiments, however, the opening 136 may be configured to receive cover (not shown) that may be fasted onto the housing 128 to enclose the air filter 108.

In the embodiment illustrated in FIG. 1, the conduit 124 extends from the hydrocarbon trap 112 to the air intake duct of the engine. The conduit 124 can comprise a smoothly transitioning arrangement of curved portions that depend upon the particular vehicle for which the system 100 is intended to be used. As such, a wide variety of different arrangements of smoothly transitioning curved portions may be contemplated, without limitation, depending upon the vehicle into which the system 100 is to be installed. The conduit 124 may comprise one or more flanges or other fittings configured to receive various ventilation hoses or sensors extending from the engine. In the illustrated embodiment of FIG. 1, the conduit 124 comprises a flange 144 configured to receive a crankcase ventilation hose (not shown).

As will be appreciated, the conduit 124 is configured to be coupled to the air intake duct of the engine and the hydrocarbon trap 112 by way of suitable fasteners. For example, as shown in FIG. 1, a pair of clamps 146 may be used to fasten the conduit 124 to the hydrocarbon trap 112 while a pair of clamps 148 may be used to maintain an airtight seal between the conduit 124 and the air intake duct of the engine.

FIG. 2 illustrates an exploded view of an exemplary embodiment of a hydrocarbon trap 112 that can be incorporated into the system 100 of FIG. 1, in accordance with the present disclosure. The hydrocarbon trap 112 comprises an outer housing 152 that couples with an inner housing 156 and at least one hydrocarbon absorbing pad 160 within an interior 164 (see FIGS. 4-5) between the outer and inner housings 152, 156. The inner housing 156 is held fixed within the outer housing 152 by way of a tamper resistant lock 166 (see FIGS. 4-5). The inner housing 156 comprises two or more mount studs 168 configured to maintain the hydrocarbon absorbing pad 160 disposed in a smooth, unfolded configuration within the interior 164. Each of the mount studs 168 has a post-like shape that extends radially outward from the exterior surface of the inner housing 156 and fits within a corresponding hole 172 disposed in the hydrocarbon absorbing pad 160. The mount studs 168 and the holes 172 are arranged to keep the hydrocarbon absorbing pad 160 disposed between the outer and inner housings 152, 156, as best shown in FIG. 4.

With continuing reference to FIG. 2, multiple ports 176 disposed along the sidewall of the inner housing 156 are configured to allow evaporative hydrocarbon emissions to be drawn to and arrested by the hydrocarbon absorbing pad 160 when the engine is not operating. The ports 176 may comprise relatively narrow openings in the inner housing 156 that allow evaporative hydrocarbon emissions to migrate into the interior 164 (see FIG. 4) between the outer and inner housings 152, 156. It should be understood, however, that the ports 176 are not to be limited to the illustrated openings, but rather the ports 176 may comprise any suitably shaped openings, without limitation. Further, it is envisioned that, in some embodiments, any of various shaped portions, ridges, channels, ducts, and any other surface features, may be incorporated into the inner housing 156 and coupled with the ports 176, as is deemed beneficial to the evaporation of hydrocarbon emissions, without limitation.

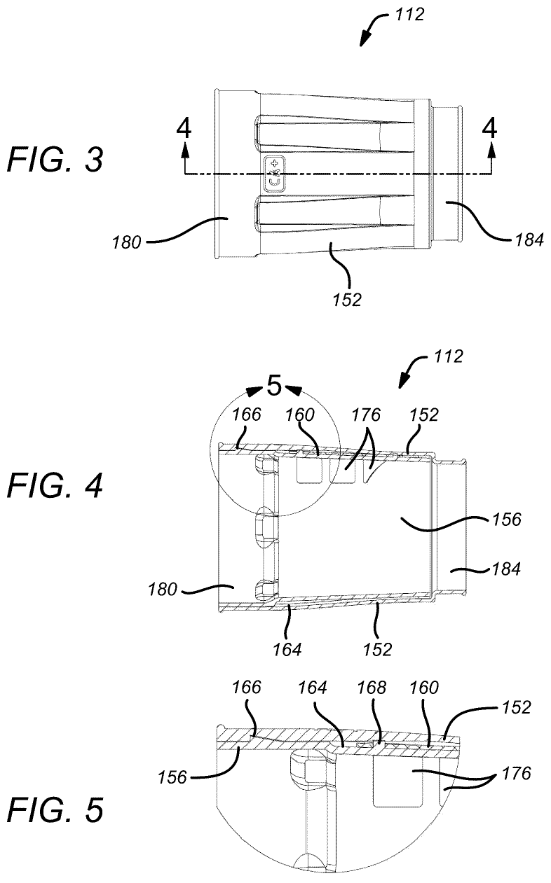

As will be appreciated, given that the hydrocarbon trap 112 is configured to arrest evaporative hydrocarbon emissions, airtight sealing between the air filter box 128, the hydrocarbon trap 112, and the conduit 124 is crucial. To this end, the outer housing 152 includes an air filter flange 180 and a conduit flange 184 at opposite ends, as shown in FIG. 3. The air filter flange 180 can be directly received into a base of the air filter 108 or may be coupled with a tube, duct, or adapter comprising the mount portion 132 of the air filter box 104 that houses the air filter 108. The conduit flange 184 can be inserted into and secured within the conduit 124 by way of the clamps 146, as shown in FIG. 1.

As best shown in the cross-sectional view of FIG. 4, the outer and inner housings 152, 156 are generally concentric with the inner housing 156 retained entirely within the interior of the outer housing 152. As will be appreciated, fastening the air filter 108 or the mount portion 132 and the conduit 124 directly onto the outer housing 152 keeps the interior 164 isolated from the atmosphere, thereby preventing evaporative hydrocarbon emissions from escaping through the interior 164 into the atmosphere. Further, as best shown in FIG. 5, the tamper resistant lock 166 serves to keep the inner housing 156 fixated within the outer housing 152. The tamper resistant lock 166 may comprise a tooth-like structure or a ridge biased toward the air filter flange 180, such that the inner housing 156 cannot be removed from the interior of the outer housing 152. Other techniques for fixating the inner housing 156 within the outer housing 152 will be apparent to those skilled in the art, without limited the spirit and scope of the present disclosure.

While the hydrocarbon absorbing air filter system and methods have been described in terms of particular variations and illustrative figures, those of ordinary skill in the art will recognize that the hydrocarbon absorbing air filter system is not limited to the variations or figures described. In addition, where methods and steps described above indicate certain events occurring in certain order, those of ordinary skill in the art will recognize that the ordering of certain steps may be modified and that such modifications are in accordance with the variations of the hydrocarbon absorbing air filter system. Additionally, certain of the steps may be performed concurrently in a parallel process, when possible, as well as performed sequentially as described above. To the extent there are variations of the hydrocarbon absorbing air filter system, which are within the spirit of the disclosure or equivalent to the hydrocarbon absorbing air filter system found in the claims, it is the intent that this patent will cover those variations as well. Therefore, the present disclosure is to be understood as not limited by the specific embodiments described herein, but only by scope of the appended claims.

What is claimed is:

1. A system for absorbing evaporative hydrocarbon emissions from an internal combustion engine, comprising:
an air filter box including one or more air inlets to an interior of the air filter box;
an air filter disposed within the interior;
a hydrocarbon trap in fluid communication with the air filter; and
a conduit extending from the hydrocarbon trap to an air intake duct of the internal combustion engine.

2. The system of claim 1, wherein the air filter is disposed within the interior and configured to remove particulate matter and contaminants that may be flowing with the airstream before the airstream passes through the hydrocarbon trap and then is directed through a conduit to an air intake duct of the internal combustion engine.

3. The system of claim 1, wherein the hydrocarbon trap is configured to absorb evaporative hydrocarbon emissions leaking from the air intake duct when the internal combustion engine is not operating.

4. The system of claim 1, wherein the air filter box generally comprises a housing that is configured to improve movement of the airstream through the air filter.

5. The system of claim 4, wherein the housing is configured to support the air filter and provides an interface between an interior of the air filter and the air intake duct of the engine.

6. The system of claim 5, wherein the housing includes a mount portion that enables coupling the air filter with an interior surface of the housing.

7. The system of claim 6, wherein the mount portion supports the air filter inside the air filter box and also supports the hydrocarbon trap outside the air filter box.

8. The system of claim 7, wherein the mount portion is secured to the housing by way of suitable fasteners.

9. The system of claim 8, wherein the hydrocarbon trap is secured to the mount portion by way of a clamp.

10. The system of claim 1, wherein the hydrocarbon trap comprises an outer housing that couples with an inner housing and at least one hydrocarbon absorbing pad within an interior between the outer housing and the inner housing.

11. The system of claim 10, wherein ports are disposed along the sidewall of the inner housing to allow evaporative hydrocarbon emissions to be drawn to and arrested by the hydrocarbon absorbing pad.

12. The system of claim 10, wherein the outer housing and the inner housing are generally concentric with the inner housing retained entirely within the interior of the outer housing to prevent evaporative hydrocarbon emissions from escaping into the atmosphere by way of the interior between the outer housing and the inner housing.

13. The system of claim 10, wherein the inner housing is held fixed within the outer housing by way of a tamper resistant lock.

14. The system of claim 13, wherein the tamper resistant lock keeps the inner housing fixated within the outer housing.

15. The system of claim 14, wherein the tamper resistant lock comprises a tooth-like structure that prevents the inner housing from being removed from the interior of the outer housing.

16. The system of claim 10, wherein the inner housing comprises two or more mount studs that maintain the hydrocarbon absorbing pad disposed in a smooth, unfolded configuration within the interior.

17. The system of claim 16, wherein the mount studs each has a post-like shape that extends radially outward from the exterior surface of the inner housing and fits within a corresponding hole disposed in the hydrocarbon absorbing pad.

18. The system of claim 17, wherein the mount studs and the holes are arranged to keep the hydrocarbon absorbing sheet disposed between the outer housing and the inner housing.

19. The system of claim 10, wherein the outer housing includes an air filter flange and a conduit flange at opposite ends.

20. The system of claim 19, wherein the air filter flange is directly received into a base of the air filter or coupled with a tube, duct, or adapter comprising a mount portion of the air filter box that houses the air filter.

21. The system of claim 20, wherein the conduit flange is inserted into and secured within the conduit by way of one or more clamps.
